(19) United States
(12) Patent Application Publication
(10) Pub. No.: US 2022/0356919 A1
(43) Pub. Date: Nov. 10, 2022

(54) ELECTRIC DRUM BRAKE FOR A ROTATABLE ELEMENT

(71) Applicant: Continental Teves AG & Co. oHG, Frankfurt am Main (DE)

(72) Inventors: Uwe Bach, Frankfurt am Main (DE); Lennart Guckes, Frankfurt am Main (DE); Martin Gädke, Frankfurt am Main (DE); Peter Stauder, Frankfurt am Main (DE); Jens Hoffmann, Frankfurt am Main (DE); Sebastian Pla, Frankfurt am Main (DE)

(21) Appl. No.: 17/620,995

(22) PCT Filed: Jun. 24, 2020
(86) PCT No.: PCT/EP2020/067643

§ 371 Date: Dec. 20, 2021

(30) Foreign Application Priority Data
Jun. 28, 2019 (DE) 10 2019 209 523.2

(51) Int. Cl. F16D 63/00; F16D 65/22; H01F 7/08

(52) U.S. Cl. CPC F16D 63/004; F16D 65/22; H01F 7/081; F16D 2121/20

(57) ABSTRACT

An electric drum brake for a rotatable element of a passenger motor vehicle. The drum brake has a brake drum and a brake surface which is connected rotationally conjointly to the brake drum, and also an electromagnet arrangement, wherein multiple brake shoes can be pushed against the brake drum by the electromagnet arrangement, and wherein the drum brake has a preloading arrangement which preloads the electromagnet arrangement into a position spaced apart from the brake surface.

### CROSS REFERENCE TO RELATED APPLICATIONS

This application is the U.S. National Phase Application of PCT International Application No. PCT/EP2020/067643, filed Jun. 24, 2020, which claims priority to German Patent Application No. 10 2019 209 523.2, filed Jun. 28, 2019, the contents of such applications being incorporated by reference herein.

### FIELD OF THE INVENTION

The invention relates to an electric drum brake for a rotatable element of a passenger motor vehicle, in particular for a shaft. It is therefore a passenger motor vehicle drum brake.

### BACKGROUND OF THE INVENTION

Conventional hydraulically actuatable drum brakes have long been used in passenger motor vehicles. A relatively new design of a drum brake is the duo-duplex drum brake, as disclosed for example in the document EP 2 518 360 A1, incorporated herein by reference.

A drum brake that can be actuated hydraulically and electromagnetically in combination, including rheostatic control and comprising a special ring-shaped brake shoe, is disclosed in U.S. Pat. No. 2,377,277 A, incorporated herein by reference. Here, a hydraulic spreading device is allocated to a recess between two ends of a flexible brake shoe, and the electromagnetic actuator acts on a single end of said brake shoe via a laterally flexible lever linkage.

### SUMMARY OF THE INVENTION

An aspect of the invention is an alternative or better design of a known drum brake.

An aspect of the invention relates to an electric drum brake for a rotatable element of a passenger motor vehicle, wherein the rotatable element may for example be a shaft. The drum brake has a brake drum which is connected rotationally conjointly to the rotatable element. The drum brake has a brake surface which is connected rotationally conjointly to the brake drum. Here, the brake surface may be attached to an element separate from the brake drum, or may also be formed on the brake drum.

The electric drum brake has an electromagnet arrangement which has at least one electrical coil which, when energized, generates a magnetic field which pushes the electromagnet arrangement against the brake surface, such that the electromagnet arrangement is concomitantly rotated to a limited extent by the brake surface. This means in particular that, typically, in the absence of energization of the electrical coil, the electromagnet arrangement is not concomitantly rotated by the brake surface, but rather is not rotated relative to a reference structure of the drum brake, for example a fastening or a housing.

The electric drum brake has at least two brake shoes. The electromagnet arrangement and the brake shoes are arranged such that the brake shoes are pushed against the brake drum by the electromagnet arrangement when the electromagnet arrangement is rotated. In particular, this enables the drum brake to be actuated.

According to a preferred embodiment, the electric drum brake has a preloading arrangement which preloads the electromagnet arrangement into a position spaced apart from the brake surface. This makes it possible to avoid constant frictional contact between the electromagnet arrangement and the brake surface, which is provided in embodiments according to the prior art. This allows, in particular, a higher mileage and greater reliability in automotive applications, which require a configuration for high speeds and long distances. It should be mentioned that the embodiment in which the electromagnet arrangement is preloaded in a position spaced apart from the brake surface can be regarded as an independent aspect of the invention.

According to one possible embodiment, the brake surface is formed on the brake drum. According to a further possible embodiment, said brake surface is formed on a disk which is separate from the brake drum and which is connected rotationally conjointly to the rotatable element.

The electromagnet arrangement may in particular be of ring-shaped design. This has been found to be advantageous in typical drum brakes. Other geometries are however also possible.

According to a preferred embodiment, the electromagnet arrangement may have a yoke with an E-shaped or a W-shaped cross section. This makes it possible, in particular, to provide two electrical coils, wherein, typically, in each case one electrical coil is arranged in one groove of the E shape or W shape. It should be mentioned that the design of the electromagnet arrangement with a yoke in an E shape or W shape can be regarded as an independent aspect of the invention.

Accordingly, according to a preferred embodiment, the electric drum brake has two electrical coils. In particular, this makes it possible to achieve a high level of redundancy. For example, if one coil fails, a second coil is available for actuating the drum brake. It is however also possible to use only one coil or more than two coils.

Preferably, each electrical coil is arranged in a respective groove of a yoke of the electromagnet arrangement. The yoke may for example have the E shape or W shape already mentioned further above. Other shapes are however also possible, that is to say the grooves for receiving the coils may also be arranged in some other manner in the yoke.

The preloading arrangement preferably has a number of springs. In this way, the desired preloading action can be achieved in a simple manner.

The electric drum brake preferably has a number of force-measuring devices between the electromagnet arrangement and the brake shoes. In this way, the force of the electromagnet arrangement acting on the brake shoes can be monitored in an advantageous manner. In addition to or instead of force-measuring devices, use may for example also be made of pressure-measuring devices, displacement-measuring devices and/or strain-measuring devices.

In a preferred embodiment, the brake drum is composed, at an end face, of steel. Said brake drum may be composed of gray cast iron in particular in a friction region of the brake shoes. Such a combination of materials has been found to be advantageous for typical applications.

According to an advantageous embodiment, the electromagnet arrangement may have a yoke composed of magnetic sheet metal. Said electromagnet arrangement may also have a friction region which, in the activated state, engages with the brake surface. Said friction region may in particular be composed of spheroidal graphite cast iron. Such embodiments and combinations of materials have been found to be advantageous for typical applications. It should be mentioned that the formation of the electromagnet arrangement from at least two materials and preferably from the materials specified here can be regarded as an independent aspect of the invention.

The electric drum break may preferably have a detent mechanism for mechanically holding the electromagnet arrangement on the brake surface. By means of such a detent mechanism, the action of the drum brake can be maintained, in particular in the activated state, even if, for example, an energization of the coil is ended. This enables the drum brake to be used as a parking brake, for example.

According to an advantageous embodiment, the electric drum brake may be arranged partially or entirely in a liquid or in transmission oil. This allows, in particular, a reduction in friction and advantageous cooling.

The electric drum brake may in particular be a duo-duplex drum brake. The embodiments described herein have been found to be particularly advantageous for such embodiments of drum brakes.

The electromagnet arrangement may in particular have a number of cams which, when the electromagnet arrangement is rotated, engage with the brake shoes so as to actuate the latter. Such an actuation by means of cams represents a simple and reliable actuation option.

The rotatable element may in particular be a shaft. Such a shaft may for example be a drive shaft or a wheel shaft of a passenger motor vehicle. At such points, a braking action is typically desired for braking the passenger motor vehicle.

The brake drum may in particular be composed of aluminum and have an inlaid magnetically conductive brake surface. Such a design offers the particular advantage of a particularly low weight owing to the use of aluminum.

According to one embodiment, multiple coils may be arranged in circularly distributed fashion with axial coil cores. This allows the use of multiple coils in a corresponding arrangement.

The electric drum brake according to an aspect of the invention is in particular a normally open brake. This means that an activation is possible only by energization, and the brake otherwise does not impart a braking action.

The electric drum brake described herein can be used particularly advantageously in vehicles with electric drive machines that can impart a proportion of the vehicle deceleration by way of the corresponding electric machines. For example, the drum brake may be used along with electric drives positioned in the centers of the wheels. In particular, said drum brake can also be used for emergency braking operations or relatively intense braking operations. However, this in no way restricts the possible usability of the drum brake according to an aspect of the invention; it can in principle be used for any braking of a rotatable element.

The measuring devices already mentioned further above may for example be configured as a measuring device for a braking torque. For example, they may be integrated in a connection between the magnetic actuator and shoes.

Electronics and/or a logic arrangement for controlling the energization of the coil may for example be arranged in the immediate vicinity of the drum brake. The electronics and/or logic arrangement may for example be arranged in an ESP control unit or some other automotive control unit.

The preloading arrangement or restoring elements, for example in the form of springs or the like, can in particular ensure a clearance between the electromagnet arrangement and the brake surface.

Through the use, as already mentioned above, of spheroidal graphite cast iron or material with similarly positive properties in the friction region, it is possible in particular for wear properties to be optimized.

### BRIEF DESCRIPTION OF THE DRAWINGS

Further features and advantages will be gathered by a person skilled in the art from the exemplary embodiment described below with reference to the appended drawing. In the drawing:

FIG. 1: shows an electric drum brake in an exploded view, and

FIG. 2: shows a sectional view of an electromagnet arrangement.

### DETAILED DESCRIPTION OF THE PREFERRED EMBODIMENTS

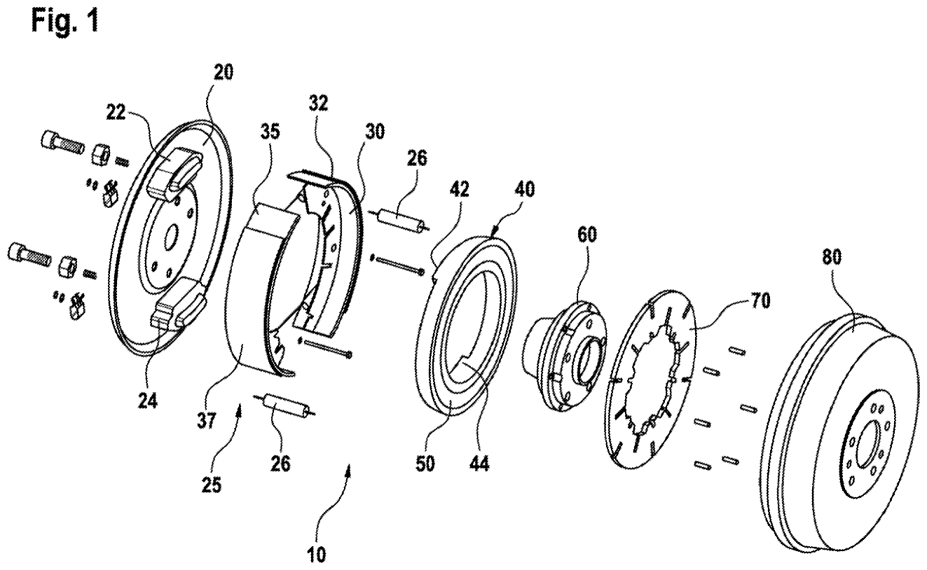

FIG. 1 shows an electric passenger motor vehicle drum brake 10 according to an exemplary embodiment of the invention.

The electric drum brake 10 has a base plate 20. Two projections 22, 24 are formed on said base plate, which projections bear further components that will be described below.

The drum brake 10 has a first brake shoe 30 and a second brake shoe 35. Respective brake linings 32, 37 are applied to the radially outer side of the brake shoes 30, 35.

The drum brake 10 has an electromagnet arrangement 40. An electrical coil 50 is arranged in said electromagnet arrangement. The electromagnet arrangement 40 is in the present case of ring-shaped design, with the coil 50 likewise being of ring-shaped design.

A first cam 42 and a second cam 44, which point toward the base plate 20, are arranged on the electromagnet arrangement 40. When the drum brake 10 is assembled with the components shown in the orientation shown, the cams 42, 44 do not yet engage with the brake shoes 30, 35. However, if the electromagnet arrangement 40 is rotated, the cams 42, 44 push the brake shoes 30, 35 radially outward. This corresponds to an activation of the drum brake 10.

The drum brake 10 has an intermediate element 60. The intermediate element 60 can in particular be mounted onto the respective wheel bearing.

The drum brake 10 has a disk 70 on which a brake surface which points toward the base plate 20, and which is thus not visible in FIG. 1, is formed. The disk 70 is mounted onto the intermediate element 60.

The drum brake 10 furthermore has a brake drum 80.

When the components shown in FIG. 1 are assembled, the disk 70 is fixedly connected to the brake drum 80, that is to say rotates together with the brake drum 80. The brake drum 80 is furthermore connected to a rotatable element (not illustrated) such as a drive shaft, wherein a braking action of the drum brake 10 is intended to act on said rotatable element. By contrast, the base plate 20 is typically fixedly installed in a vehicle, such that the rotatable element rotates together with the brake drum 80 and the disk 70 relative to the base plate 20.

The electromagnet arrangement 40 is preloaded into its basic position, such that it is spaced apart from the disk 70, by a preloading arrangement 25 with two schematically illustrated springs 26. Constant friction of the electromagnet arrangement 40 can thereby be avoided. If the coil 50 is energized, it is pulled against the brake surface of the disk 70 owing to the magnetic action. Since the disk 70 rotates, the electromagnet arrangement 40 is thus also concomitantly rotated, specifically owing to the resulting friction. In this way, as already described further above, the two brake shoes 30, 35 are pushed outward, whereby the brake linings 32, 37 engage with the brake drum 80. This generates a braking action.

It should be mentioned that the friction of the electromagnet arrangement 40 against the brake surface of the disk 70 already creates friction. This also already generates a braking action, such that the two braking actions are added together.

The design shown corresponds to that of a duo-duplex drum brake.

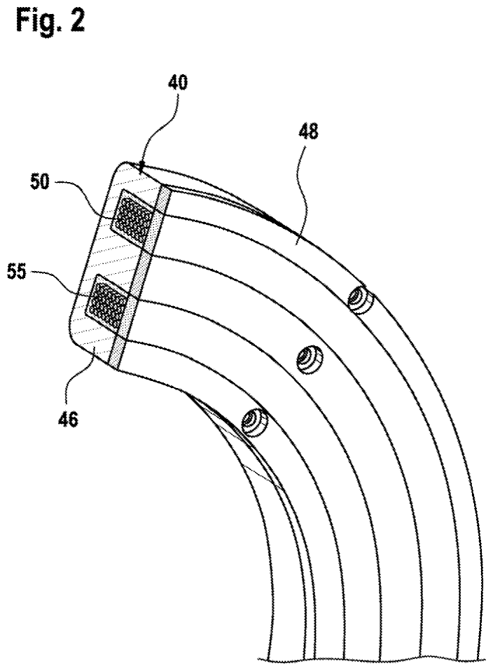

FIG. 2 shows a slightly modified form of an electromagnet arrangement 40, which may also be used in the embodiment of FIG. 1. Here, the electromagnet arrangement 40 has a yoke 46 in an E shape, such that two grooves are created in the yoke 46. A respective coil 50, 55 is arranged in each of these grooves, which coils are electrically independent of one another. In the present case, an embodiment with two coils 50, 55 is thus provided. This increases the redundancy.

Toward the brake surface of the disk 70, the electromagnet arrangement 40 has a friction region 48, which may be formed from a different material than the yoke 46. In particular, spheroidal graphite cast iron may be used for the friction region 48. This has been found to be advantageously particularly durable for the intended use, which causes friction upon every braking operation.

It is pointed out that, for faster deactivation of the drum brake 10, residual magnetization can be actively reduced. For this purpose, an alternating, falling current amplitude can be applied to the magnet.

The embodiment shown and described has been found to be an inexpensive electrical actuator which can withstand a long service life and which is resistant to corrosion and/or contamination. Constant friction can be eliminated, as the inventors of this application have found out. The drum brake shown can in particular be of encapsulated design, which leads to a high level of availability. It can be integrated in compact fashion in a series installation space. It may also be designed as a dry brake without hydraulic supply devices, and typically requires only an electrical connection for the purposes of activation.

It is pointed out that features may be described in combination in the claims and in the description, for example to facilitate understanding, although these may also be used separately from each other. The person skilled in the art will gather that such features may also be combined with other features or feature combinations independently of each other.

Dependency references in the dependent claims may characterize preferred combinations of the respective features but do not exclude other feature combinations.

### LIST OF REFERENCE SIGNS

10: Electric drum brake
20: Base plate
22: Projection
24: Projection
25: Preloading arrangement
26: Springs
30: Brake shoe
32: Brake lining
35: Brake shoe
37: Brake lining
40: Electromagnet arrangement
42: Cam
44: Cam
46: Yoke
48: Friction region
50: Coil
55: Coil
60: Intermediate element
70: Disk
80: Brake drum

1. An electric drum brake for a rotatable element of a passenger motor vehicle,
wherein the drum brake comprises:
a brake drum which is connected rotationally conjointly to the rotatable element;
a brake surface which is connected rotationally conjointly to the brake drum;
an electromagnet arrangement which has at least one electrical coil which, when energized, generates a magnetic field which pushes the electromagnet arrangement against the brake surface, such that the electromagnet arrangement is concomitantly rotated to a limited extent by the brake surface; and
at least two brake shoes,
wherein the electromagnet arrangement and the brake shoes are arranged such that the brake shoes are pushed against the brake drum by the electromagnet arrangement when the electromagnet arrangement is rotated, and
wherein the drum brake has a preloading arrangement which preloads the electromagnet arrangement into a position spaced apart from the brake surface.

2. The electric drum brake as claimed in claim 1,
wherein the brake surface is formed on the brake drum or is formed on a disk which is separate from the brake drum and which is connected rotationally conjointly to the rotatable element.

3. The electric drum brake as claimed in claim 1,
wherein the electromagnet arrangement is of ring-shaped design.

4. The electric drum brake as claimed in claim 1,
wherein the electromagnet arrangement has a yoke with an E-shaped or a W-shaped cross section.

5. The electric drum brake as claimed in claim 1,
wherein the electromagnet arrangement has two electrical coils.

6. The electric drum brake as claimed in claim 5,
wherein each electrical coil is arranged in a respective groove of a yoke of the electromagnet arrangement.

7. The electric drum brake as claimed in claim 1,
wherein the preloading arrangement has a number of springs.

8. The electric drum brake (10) as claimed in claim 1,
comprising a number of force-measuring devices between the electromagnet arrangement (40) and the brake shoes (30, 35).

9. The electric drum brake as claimed in claim 1,
wherein the electromagnet arrangement has a yoke composed of magnetic sheet metal and/or a friction region which is composed of spheroidal graphite cast iron and which in the activated state engages with the brake surface.

10. The electric drum brake as claimed in claim 1,
comprising a detent mechanism for mechanically holding the electromagnet arrangement on the brake surface.

11. The electric drum brake as claimed in claim 1,
which is partially or entirely arranged in a liquid or in transmission oil.

12. The electric drum brake as claimed in claim 1,
wherein the drum brake is a duo-duplex drum brake.

13. The electric drum brake as claimed in claim 1,
wherein the electromagnet arrangement has a number of cams which, when the electromagnet arrangement is rotated, engage with the brake shoes so as to actuate the latter.

14. The electric drum brake as claimed in claim 1,
wherein the brake drum is composed of aluminum and has an inlaid magnetically conductive brake surface.

15. The electric drum brake as claimed in claim 1,
wherein multiple coils are arranged in circularly distributed fashion with axial coil cores.
